(19) United States
(12) Patent Application Publication
(10) Pub. No.: US 2006/0122999 A1
(43) Pub. Date: Jun. 8, 2006

(54) Apparatus for and method of producing graphics contents and computer-readable recording medium storing computer program for executing the method

(75) Inventors: Alexei Sosnov, Moscow (RU); Hui Zhang, Yongin-si (KR); Seokyoon Jung, Seoul (KR); Shinjun Lee, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/229,501

(22) Filed: Sep. 20, 2005

(30) Foreign Application Priority Data
Dec. 6, 2004 (KR) 10-2004-0101651

(51) Int. Cl. G06F 17/30

(52) U.S. Cl. 707/5

(57) ABSTRACT

An apparatus for and method of producing graphics contents and a computer-readable recording medium storing a computer program for executing the method are provided. The apparatus produces graphics contents using a query item, which is a query object indicating graphics contents that a user desires to produce. The apparatus includes: a model database storing a plurality of models that can match a predetermined query item and shape descriptors of the models; a model-retrieving unit comparing a shape descriptor extracted from a given query item with the shape descriptors of the models stored in the model database and outputting one or more models within a predetermined degree of similarity for user selection; and a model-refining unit refining the selected model according to an instruction from the user and generating a user-intended model. Therefore, three-dimensional graphics contents can be produced quickly and accurately.

### CROSS-REFERENCE TO RELATED APPLICATIONS

This application claims the benefit of Korean Patent Application No. 10-2004-0101651, filed on Dec. 6, 2004, in the Korean Intellectual Property Office, the disclosure of which is incorporated herein in its entirety by reference.

### BACKGROUND OF THE INVENTION

1. Field of the Invention

The present invention relates to producing graphics contents, and more specifically, to an apparatus for and method of producing graphics contents by deforming and refining graphics contents obtained using a class model and a computer-readable recording medium storing a computer program for executing the method.

2. Description of the Related Art

There are various technologies for producing 3D graphics contents.

FIG. 1 is a block diagram of a conventional apparatus for producing 3D graphics contents by retrieval. Referring to FIG. 3, a query item, i.e., a query object, is input to a model-producing unit 110 from a query item input unit 100. The model-producing unit 110 retrieves and outputs 3D graphics contents most similar to the input query item from 3D graphics contents stored in a model-storing unit 120. OUT1 indicates the output 3D graphics contents.

The conventional apparatus can produce 3D graphics contents more quickly when using the model-storing unit 120 compared with when not using the model-storing unit 120. However, retrieved contents hardly match contents to be produced. This problem worsens when the number of models stored in the model-storing unit 120 is small.

To solve this problem, a technology for storing as much 3D graphics contents as possible in the model-storing unit 120 has been suggested. However, the storage space of the model-storing unit 120 is limited, and it is still difficult for retrieved contents to exactly match 3D graphics contents to be produced.

### SUMMARY OF THE INVENTION

Additional aspects and/or advantages of the invention will be set forth in part in the description which follows and, in part, will be apparent from the description, or may be learned by practice of the invention.

The present invention provides an apparatus for quickly and accurately producing graphics contents using a class model, which is a category representation corresponding to each type of graphics contents.

The present invention also provides a method of quickly and accurately producing graphics contents using a class model, which is a category representation corresponding to each type of graphics contents.

The present invention also provides a computer-readable recording medium storing a computer program for executing a method of quickly and accurately producing graphics contents using a class model, which is a category representation corresponding to each type of graphics contents.

According to an aspect of the present invention, there is provided an apparatus for producing graphics contents using a query item, which is a query object indicating graphics contents that a user desires to produce. The apparatus includes: a query-generating unit generating a query composed of one or more query items; a model database storing a plurality of models that can match a predetermined query item and shape descriptors of these models; a model-retrieving unit comparing a shape descriptor extracted from a given query item with the shape descriptors of the models stored in the model database, outputting one or more models within a predetermined degree of similarity, and selecting according to a user's choice one model most relevant to the query; and a model-refining unit refining the selected model according to an instruction from the user and generating a user-intended model. The shape descriptor describes a shape based on properties including geometric and topologic properties.

According to another aspect of the present invention, there is provided an apparatus for producing graphics contents using a query item, which is a query object indicating graphics contents that a user desires to produce. The apparatus includes: a query-generating unit generating a query composed of one or more query items; a model database storing a plurality of models that can match a predetermined query item and shape descriptors of these models; a model-retrieving unit comparing a shape descriptor extracted from a given query item with the shape descriptors of the class models stored in the model database and outputting one or more class models within a predetermined degree of similarity, and selecting according to a user's choice one model most relevant (from a user's point of view) to the query; and a model-deformation unit deforming properties of the selected class models and according the properties of the selected class models and properties of the given query item. The class model is a category representation corresponding to each kind of graphics contents and properties of the class model are determined as variable, and the shape descriptor describes a shape based on properties including geometric and topologic properties.

The apparatus may further include a model-refining unit refining the class models having deformed properties according to an instruction from the user and generating a user-intended model.

The query-generating unit may further include a node-generating unit generating a plurality of nodes respectively corresponding to parts of a shape of the graphics contents that the user desires to produce, having properties of the parts, and having a plurality of three-dimensional shapes; and a three-dimensional structural sketch-generating unit disposing the nodes according to the properties of the nodes.

According to another aspect of the present invention, there is provided a method of producing graphics contents using a query item, which is a query object indicating graphics contents that a user desires to produce. The method includes generating a query composed of one or more query items; receiving the query, and retrieving one or more models, which can have shape descriptors within a predetermined degree of similarity with a shape descriptor extracted from the received query, from a plurality of models which can match a predetermined query item, and selecting according to a user's choice one model most relevant (from a user's point of view) to the query; and refining the retrieved model according to an instruction from the user and generating a user-intended model. The shape descriptor describes a shape based on properties including geometric and topologic properties.

According to another aspect of the present invention, there is provided a method of producing graphics contents using a query item, which is a query object indicating graphics contents that a user desires to produce. The method includes: generating a query composed of one or more query items; receiving the query, and retrieving one or more models, which can have shape descriptors within a predetermined degree of similarity with a shape descriptor extracted from the received query, from a plurality of models which can match a predetermined query item, and selecting according to a user's choice one model most relevant (from a user's point of view) to the query; and deforming properties of the selected class model and according the properties of the selected class model and properties of the received query. The class model is a category representation corresponding to each kind of graphics contents and properties of the class model is determined as a variable, and the shape descriptor describes a shape based on properties including geometric and topologic properties.

The method further may include refining the deformed model according to an instruction from the user and generating a user-intended model.

The receiving of the query and the retrieving of the one or more models may include: receiving the query and extracting the shape descriptor from the received query; comparing the shape descriptors of the models stored with the extracted shape descriptor; and outputting one or more models within a predetermined degree of similarity based on the result of the comparison.

The receiving of the query and the retrieving of the one or more models may further include receiving a selection of a model among the outputted models by the user, and in the outputting of one or more models, a plurality of models may be outputted.

According to another aspect of the present invention, there is provided a computer-readable recording medium having recorded thereon at least one computer program for executing a method of producing graphics contents using a query item, which is a query object indicating graphics contents that a user desires to produce. The method includes: generating a query composed of one or more query items; receiving the query, and retrieving one or more models, which can have shape descriptors within a predetermined degree of similarity with a shape descriptor extracted from the received query, from a plurality of models which can match a predetermined query item, and selecting according to a user's choice one model most relevant (from a user's point of view) to the query; and refining the selected models according to an instruction from the user and generating a user-intended model. The shape descriptor describes a shape based on properties including geometric and topologic properties.

According to another aspect of the present invention, there is provided a computer-readable recording medium having recorded thereon at least one computer program for executing a method of producing graphics contents using a query item, which is a query object indicating graphics contents that a user desires to produce. The method includes: generating a query composed of one or more query items; receiving the query, and retrieving one or more models, which can match have shape descriptors within a predetermined degree of similarity with a shape descriptor extracted from the received query, from a plurality of models which can match a predetermined query item, and selecting according to a user's choice one model most relevant (from a user's point of view) to the query; and deforming properties of the selected models and according the properties of the selected models and properties of the received query. The class model is a category representation corresponding to each kind of graphics contents and properties of the model is determined as a variable, and the shape descriptor is a language that describes a shape based on properties including geometric and topologic properties.

According to another aspect of the present invention, there is provided an apparatus for producing graphics contents using a query item, which is a query object indicating graphics contents that a user desires to produce, the apparatus comprising: a model-retrieving unit comparing a shape descriptor extracted from a given query item with shape descriptors of models stored in a model database and outputting one or more models within a predetermined degree of similarity for user selection; and a model-refining unit refining a user-selected model according to an instruction from the user and generating a user-intended model, wherein the shape descriptor describes a shape based on properties including geometric and topologic properties.

According to another aspect of the present invention, there is provided an apparatus for producing graphics contents using a query item, which is a query object indicating graphics contents that a user desires to produce, the apparatus comprising: a model-retrieving unit comparing a shape descriptor extracted from a given query item with shape descriptors of class models stored in a model database and outputting one or more class models within a predetermined degree of similarity for user selection; and a model-deformation unit deforming properties of a user-selected class model and according properties of the user-selected class model and properties of the given query item, wherein the class model is a category representation corresponding to each kind of graphics contents and properties of the class model are determined as a variable, and wherein the shape descriptor describes a shape based on properties including geometric and topologic properties.

### BRIEF DESCRIPTION OF THE DRAWINGS

These and/or other aspects, features, and advantages of the invention will become apparent and more readily appreciated from the following description of the embodiments, taken in conjunction with the accompanying drawings of which:

FIG. 1 is a block diagram of a conventional apparatus for producing three-dimensional (3D) graphics contents;

FIGS. 2 and 3 are schematic block diagrams of apparatuses for producing graphics contents according to exemplary embodiments of the present invention;

FIG. 4 is a flowchart illustrating a method of producing graphics contents according to exemplary embodiments of the present invention;

FIG. 5 illustrates examples of a query item;

FIG. 6 is a reference diagram for explaining an example of a class model in more detail;

FIG. 7 illustrates examples of models retrieved by a model-retrieving unit of FIG. 2 after receiving query items illustrated in FIG. 5;

FIG. 8 is a reference diagram for explaining a model deformation process according to an exemplary embodiment of the present invention in more detail;

FIG. 9 is a reference diagram for explaining a model deformation process according to another exemplary embodiment of the present invention in more detail;

FIG. 10 is a block diagram of an apparatus for producing graphics contents according to another exemplary embodiment of the present invention;

FIG. 11 is a block diagram of an apparatus for producing graphics contents according to another exemplary embodiment of the present invention.

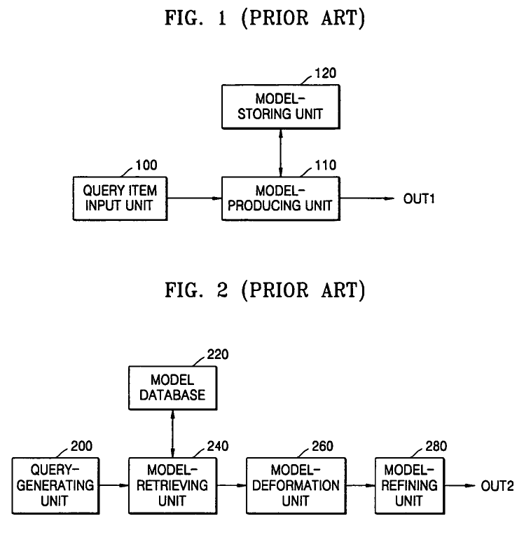

### DETAILED DESCRIPTION OF THE PREFERRED EMBODIMENTS

The present invention will now be described more fully with reference to the accompanying drawings, in which exemplary embodiments of the invention are shown, and in which like reference numerals refer to like elements throughout. The invention may, however, be embodied in many different forms and should not be construed as being limited to the exemplary embodiments set forth therein; rather, these exemplary embodiments are provided so that this disclosure will be thorough and complete, and will fully convey the concept of the invention to those skilled in the art.

Terms used herein are defined in consideration of functions of elements expressed by the terms. The definitions of the terms may be changed according to intentions or customs of their users. Therefore, the terms shall be defined based on the contents of the entire specification.

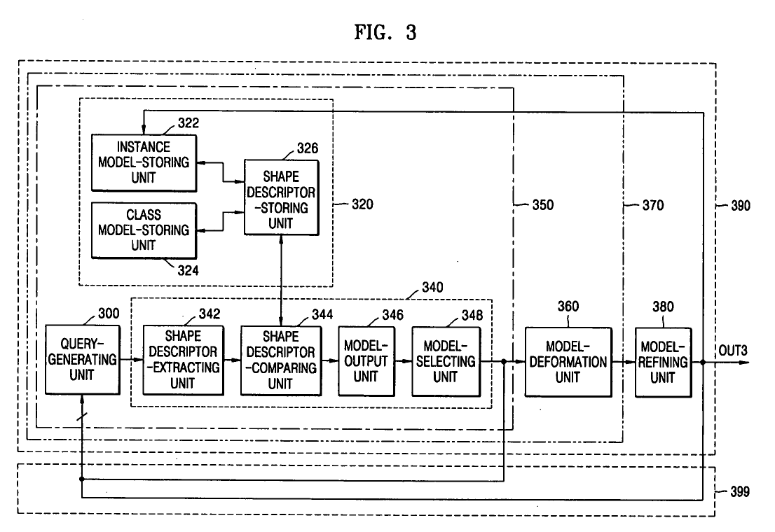

FIGS. 2 and 3 are schematic block diagrams of apparatuses for producing graphics contents (hereinafter, called present apparatuses) according to exemplary embodiments of the present invention. Each of the present apparatuses includes a query-generating unit 200 or 300, a model database 220 or 320, a model-retrieving unit 240 or 340, a model-deformation unit 260 or 360, and a model-refining unit 280 or 380.

OUT2 and OUT3 indicate contents output by the model-refining unit 280 and 380, respectively, and OUT2 is identical to OUT3. The operations of the query-generating unit 200, the model database 220, the model-retrieving unit 240, the model-deformation unit 260, and the model-refining unit 280 illustrated in FIG. 2 are identical to those of the query-generating unit 300, the model database 320, the model-retrieving unit 340, the model-deformation unit 360, and the model-refining unit 380 illustrated in FIG. 3.

The query-generating unit 300 generates a query composed of one or more query items. A query item, i.e., a query object, denotes graphics contents that a user desires to produce. Query items are input by the user. The graphics contents that the user desires to produce may be three-dimensional (3D).

For example, the query item may include a sketch query, a text query and a sample query. Here, the sketch query may include a two-dimensional (2D) contour sketch, a 3D-shape sketch, and a structural sketch. The structural sketch may include a 2D-structural sketch and a 3D-structural sketch. The sample query may include a 2D image sample and a 3D model sample.

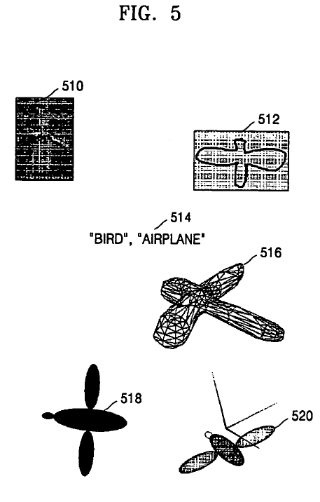

FIG. 5 illustrates examples of the query item. Reference numerals 510, 512, 514, 516, 518, and 520 indicate a sample query, a 2D-contour sketch, a text query, a 3D-shape sketch, a 2D-structural sketch, and a 3D-structural sketch, respectively. 3D graphics contents that a user desires to produce is a bird or an airplane. The user may input at least one of the sample query 510, the 2D-contour sketch 512, the text query 514, the 3D-shape sketch 516, the 2D-structural sketch 518, and the 3D-structural sketch 520 as a query object indicating the bird or the airplane.

The 2D-contour sketch 512 is obtained by sketching the two-dimensional contours of the airplane, and the 2D-structural sketch 518 is obtained by sketching the two-dimensional framework of the airplane using an ellipse.

The query items 510, 512, 514, 516, 518, and 520 may be expressed in various formats and are input to the model-retrieving unit 320 as a query. A query may be composed of one query item 510, 512, 514, 516, 518, or 520 or a plurality of query items among all the query items 510, 512, 514, 516, 518, and 520. When the plurality of query items among all the query items 510, 512, 514, 516, 518, and 520 are inputted to the model-retrieving unit 340 as a query, the query is called a multimodal query.

The model database 320 stores a plurality of models, which can match a predetermined query item, and shape descriptors of the models, which are used to compute similarity of models and query items. The model database 320 may store the models and the shape descriptors of the models in advance.

The models stored in the model database 320 may be two-dimensional or three-dimensional. However, 3D models are preferred. The models stored in the model database 320 may be of different geometry representation.

For the sake of convenience, it is assumed that instance models stored in the model database 320 are 3D instance models belonging to some category and class models stored in the model database 320 are category representation of 3D models. The meanings of an instance model and a class model will later be described.

A shape descriptor describes a shape based on its properties including geometric and topologic properties. Therefore, all models stored in the model database 320 and query items with shapes, which are generated by the query-generating unit 300, have shape descriptors.

If two models have different shape descriptors, the two models are different from each other. If the two models have partly identical shape descriptors, they share some properties. If the shape descriptors of the two models match exactly, the models share all of their properties. Ultimately, a shape descriptor is the key to a model or a query item.

The model database 320 stores at least one of an instance model and a class model. A class model is a category representation of each kind of graphics contents and the properties of the class model are determined as a variable. A class model can be only a subject of Affine or Euclidean transformation. An instance model refers to all possible models for each kind of graphics contents and the properties of the instance model are determined as an invariable. Properties include geometric and topologic properties.

There can be one or more instance models and class models. However, there may be only one class model. For example, it is assumed that a user desires to produce an airplane as graphics contents. In this case, at least one of instance and class models of the airplane are stored in the model database 320. Here, the instance model refers to a model whose properties are determined as invariable and indicating an airplane. Therefore, all of models indicating an airplane may be instance models. The class model refers to a category representation for many instance models whose properties are not determined; those properties are determined during class model deformation. While there are an unlimited number of instance models of an airplane, the number of class models is limited. The class model of an airplane may be graphics contents composed of a body and wings disposed on both sides of the body. The geometric and topologic properties of the body and the wings are not determined.

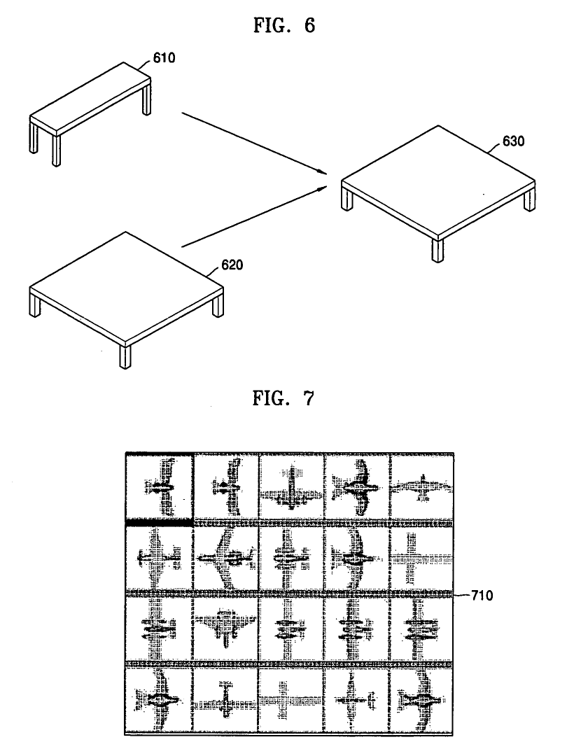

FIG. 6 is a reference diagram for explaining a class model in more detail. There are numerous instance models representing a desk composed of a board and four legs. However, for the sake of convenience, two instance models are illustrated in FIG. 6. One of possible representative instance models in the class of desk is illustrated on the right side of FIG. 6.

The width of a board, the length of an edge, and the length of legs may be parameters of the model of a desk. While a parameter value of each instance model is invariable, a parameter value of a class model is a variable.

Referring to FIG. 6, properties, such as geometric and topologic properties, of two instance models 610 and 620, and a class model 630 do not exactly match. Thus, shape descriptors extracted from the instance models 610 and 620 and the class model 630 are different from one another.

However, the instance models 610 and 620 and the class model 630 share geometric and topologic properties in that each of them is composed of one board and four legs. Thus, some of the shape descriptors of the instance models 610 and 620 and the class model 630 match. Therefore, the shape descriptor of the instance model 610 or 620 belongs to the shape descriptor of the class model 630 of the desk. That is, the instance models 610 and 620 are a subset of the class model 630.

In this regard, if the class model 630 is stored in the model database 320, it means that the instance models 610 and 620 are unnecessary to be stored in the model database 320. As a result, storage efficiency can be enhanced, thereby facilitating quick and efficient retrieval.

As described above, instance models can be stored in the model database 320. However, since the number of possible instance models is unlimited, some of the instance models may be selected and stored in the model database 320 to enhance storage efficiency. Sub instance models may be stored for given category of graphics contents: if class models are unavailable, or too complicated to develop, for instance, as for foliate trees; or if it is an important instance in a given class; or if it is difficult to be achieved by the deformation procedure described below. The model database 320 can store a predetermined number of instance models 610 and 620, and a predetermined number of class model 630 at the same time. The shape descriptors extracted from the instance models 610 and 620 and the class model 630 may also be stored in the model database 320.

For example, when models of a desk, a chair, a house, and a tree are to be stored in the model database 320, three instance models and one class model for each of the desk, the chair, the house, and the tree may be stored in the model database to enhance the storage efficiency of the model database 320. A total of 16 models are stored in the model database 320 and 12 instance models out of the 16 models are categorized (classified) into four groups (desk, chair, house, and tree) according to their shape descriptors.

The model database 320 includes an instance model-storing unit 322, a class model-storing unit 324, and a shape descriptor-storing unit 326. The instance model-storing unit 322 and the class model-storing unit 324 store instance models and class models, respectively. Each model can be expressed by a shape descriptor and shape descriptors of all models stored in the model database 320 are stored in the shape descriptor-storing unit 326.

The model-retrieving unit 340 receives a query, compares a shape descriptor extracted from the received query with shape descriptors of models stored in the model database 320, and outputs one or more models within a predetermined degree of similarity. It is important that, when both instance models and class models are stored in the model database 320, shape descriptors of both instance models and class models are compared with the shape descriptor extracted from the received query, and both instance model and class models can be outputted simultaneously, making possible to retrieve models for query items that describe graphics contents typical for a particular or representative cases.

The model-retrieving unit 340 includes a shape descriptor-extracting unit 342, a shape descriptor-comparing unit 344, a model output unit 346, and a model-selecting unit 348.

The shape descriptor-extracting unit 342 receives a query and extracts a shape descriptor from the received query. The shape descriptor-comparing unit 344 compares shape descriptors of models stored in the shape descriptor-storing unit 326 with the shape descriptor extracted by the shape descriptor extracting-unit 342. Based on the comparison, the shape descriptor-comparing unit 344 determines one or more shape descriptors within a predetermined degree of similarity with the shape descriptor extracted by the shape descriptor-extracting unit 342.

The shape descriptor-comparing unit 344 need not necessarily compare all of the models stored in the model database 320 with the received query. The shape descriptor-comparing unit 344 may compare the received query with only all of the instance models or the class models stored in the model database 320.

The model output unit 346 outputs one or more models within a predetermined degree of similarity based on the result of comparison made by the shape descriptor-comparing unit 344. The model output unit 346 outputs only one model when the shape descriptor-storing unit 326 stores a shape descriptor that exactly matches the extracted shape descriptor. However, such a case is rare.

For example, if a query generated by the query-generating unit 300 is composed of query items indicating an “airplane,” the model output unit 346 included in the model-retrieving unit 340 outputs one or more models having shape descriptors within a predetermined degree of similarity with the shape descriptor of the received query. The models output from the model output unit 346 may be instance models and/or class models. The model output unit 346 may output “airplane” models or “bird” models, or output various types of “airplane” model.

FIG. 7 illustrates models 710 retrieved by the model-retrieving unit 240 of FIG. 2 after receiving query items illustrated in FIG. 5. Referring to FIG. 7, the models 710 outputted from the model output unit 346 include a plurality of “airplane” models and a plurality of “bird” models since shape descriptors of the “airplane” and “bird” models may be similar. Therefore, the model-selecting unit 348 is needed.

The model-selecting unit 348 may select one model among the models outputted from the model output unit 346 according to a user's decision. If the model output unit 346 outputs only one model, the model-selecting unit 348 may not be needed. Consequently, the model-retrieving unit 340 may retrieve and output only one model.

Only one outputted model by the model output unit 346, or only one selected model by the model-selecting unit 348 is a retrieved instance model or a retrieved class model. In other words, a process of retrieving a predetermined model using the model-retrieving unit 340 is performed by blocks included in an area indicated by reference numeral 350 in FIG. 3. And this retrieved model may be fed into the query-generating unit 300 as a query item, in order to generate a query.

The model-retrieving unit 340 may further include a retrieval feedback unit (not shown). The retrieval feedback unit adds the model output from the model output unit 346 as a query item that the query-generating unit 300 uses to generate a query. As described above, a query is a combination of query items. Therefore, the more query items are combined, the more elaborate query can be generated. When a query item is added by the retrieval feedback unit, the query-generating unit 300 can generate a query that more elaborately describes graphics contents that a user desires to produce. In this way, a query generated by the query-generating unit 300 is updated.

In other words, a query generated by the query-generating unit 300 is updated by a model fed back from the retrieval feedback unit (not shown). Such re-operations of the query-generating unit 300 and the model-retrieving unit 340 make it possible to produce graphics contents desired by a user more elaborately and accurately. Re-retrieval by the re-operations of the query-generating unit 300 and the model-retrieving unit 340 is called incremental retrieval.

A retrieved instance model goes through the model-refining unit 380 and a retrieved class model goes through the model-deformation unit 360 and the model-refining unit 380. The class model may go through only the model-deformation unit 360.

Such model deformation and refining processes are required as part of producing graphics contents since it is difficult for the retrieved instance model and the retrieved class model to completely match graphics contents that a user originally intended to produce.

The model-deformation unit 360 deforms properties of the retrieved class model such that the properties of the retrieved class model match those of the query received by the shape descriptor-extracting unit 342. Such a deformation process may be automatically conducted by the present apparatus, not in response to an instruction from a user.

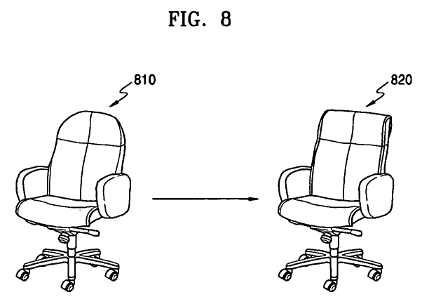

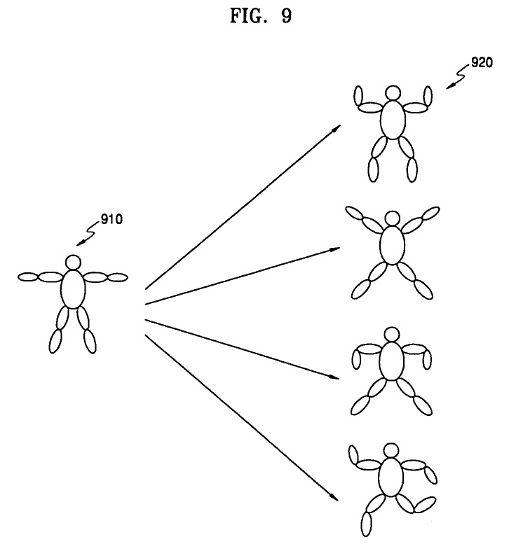

To deform a model is to automatically designate a parameter value of the retrieved class model in order to accord the properties of the retrieved class model and the properties of the received query. FIG. 8 is a reference diagram for explaining a model deformation process according to an exemplary embodiment of the present invention in more detail. A retrieved class model 810 is a class model of “chair.” In other words, the model output unit 346 outputted class models having shape descriptors that are similar to “chair” out of all class models stored in the model database 320 and a user selected the class model 810 of “chair” from the outputted class models. The class model 810 of FIG. 8 may have the number of legs, the length of the legs, the shape of the back of the chair, and the width of the sitting part of the chair as parameters. Values of the parameters are variables since the parameters are of the class model 810.

If a query is composed of query items indicating that a chair has three legs and a square back, the retrieved class model 810 is deformed according to the query and a deformed class model 820 is generated.

A class model may be represented in various forms. A class model represented as a parameter set, as described above, is called a parametric class model. A class model represented as a combination of properties of each part of an object is called a deformable part-based class model.

The retrieved class model 810 can be deformed using a parametric fitting method or a part-based freeform deformation method. A parametric class model may be deformed using the parametric fitting method and a deformable part-based class model may be deformed using the part-based freeform deformation method.

In the parametric fitting method, each parameter value is deformed. Specifically, in a constraint-based parametric fitting method, when a parameter value is deformed, other parameter values constrained by the deformed parameter value are deformed accordingly.

For example, it is assumed that a class model of “desk” has the shape of a board of a desk, the width of the board, and the radius of the board, if the board is round, as parameters and that an input query is composed of query items indicating a desk having a round board whose width is A. If a retrieved class model is a desk having a round board whose width is B, the retrieved class model is deformed by the model-deformation unit 360 such that the width of its round board becomes A. Here, the parameter value of the radius of the board is also deformed in addition to the width of the board due to the following constraint.
3.1415927*radius*radius=width (1)

In this way, when the parameter of radius is deformed as the parameter of width is deformed, it is called the constraint-based parametric fitting.

For another example of constraint-based parametric fitting, it is assumed that a class model of “desk” has the shape of a board of a desk, the width of board, the height of the legs as parameters, and specifies that all the legs have equal height (constraint 1); and an input query is composed of query items indicating a desk having very tall (with respect to the height of the desk) legs, which heights are unequal (due to imprecision of input of query items such as for sketch queries) and maximal height is A. If a retrieved class model is a desk having legs whose height is equal and is B, the retrieved class model is deformed by the model-deformation unit 360 such that one leg obtains height A, other legs automatically obtain equal height A from the constraint 1. In this way, when parameters of a class models are deformed in a coordinated fashion to respect imposed constraints, consistent models are obtained; constraints, which are the parts of class models definitions, have more priority to respect than to exact fit the query items.

The part-based freeform deformation is to deform properties of each part constituting the retrieved class model 810. While the parameter values of the class model 810 are deformed in the parametric fitting, the properties of each part of the class model 810 are deformed in the part-based freeform deformation; parts can be deformed by independent constraint-based fitting as described above, or by applying anisotropic transformations, and an instance model is re-assembled from deformed parts such that constraints on model structure and on part relations imposed by a class model are applied.

FIG. 9 is a reference diagram for explaining a model deformation process according to another exemplary embodiment of the present invention in more detail. Topologic properties of each part of a class model 910 on the left side of FIG. 9 are deformed and deformed class models 920 are generated.

Since a parameter value of an instance model is invariable, unlike that of a class model, the instance model does not require model deformation. The model-deformation unit 360 deforms only class models, not instance models, which are retrieved by the model-retrieving unit 340. In other words, the process of deforming a predetermined model using the model-deformation unit 360 is performed by blocks included in an area indicated by reference numeral 370 in FIG. 3.

The model-refining unit 380 refines an instance model or a class model retrieved by the model-retrieving unit 340 and generates a user-intended model. To refine a model is to modify a retrieved instance model, a deformed class model, or a retrieved class model in response to an instruction from a user. For example, a retrieved sub class instance model can be rescaled to match user intentions about its size. In other words, a process of refining a predetermined model using the model-refining unit 380 is performed by blocks included in an area indicated by reference numeral 390 in FIG. 3.

The model-refining unit 380 may further include a refining feedback unit (not shown). The refining feedback unit adds an instance model or a class model refined by the model-refining unit 380 as a query item that the query-generating unit 300 uses.

In other words, the refining feedback unit (not shown) supplies a refined model as a query item that the query-generating unit 300 uses to generate a query. In this case, since a query item is added, the query-generating unit 300 can generate a query that more elaborately describes graphics contents that a user desires to produce. In this way, a query generated by the query-generating unit 300 is updated.

Here, when the query-generating unit 300, the model-retrieving unit 340, and the model-refining unit 380 are re-operated, the present apparatus can produce graphics contents desired by the user more elaborately and accurately. That is, since an updated query for the graphics contents that the user desires to produce is fancier than a previous query before being updated, if the updated query is processed by the model-retrieving unit 320, the model-deformation unit 360, and the model-refining unit 380 again, a more satisfactory result can be obtained.

The model-refining unit 380 may further include a refined model-adding unit (not shown). The refined model-adding unit (not shown) adds a model refined by the model-refining unit 380 to the model database 320. In other words, an instance model or a class model refined by the model-refining unit 380 can be added to the model database 320, which is also a process for obtaining a more satisfactory result when the retrieval, deformation, and refining of a model are repeated.

The more a query generated by the query-generating unit 300 is repeatedly updated, retrieved, deformed, and refined, the user can produce the desired graphics contents more elaborately. In other words, a process of updating a query generated by the model-generating unit 300 is performed by blocks included in an area indicated by reference numeral 399 in FIG. 3.

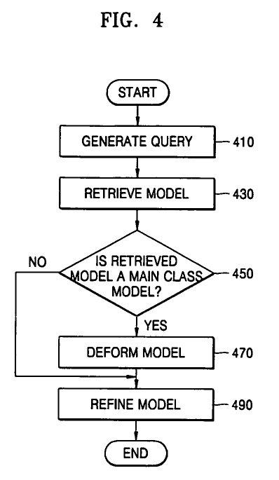

FIG. 4 is a flowchart illustrating a method of producing graphics contents according to an exemplary embodiment of the present invention. The method includes generating a query (operation 410), retrieving the model (operation 430), deforming the model (operation 470), and refining the model (operation 490).

First, the query-generating unit 300 generates a query composed of one or more query items (operation 410). The model-retrieving unit 340 retrieves, from the model database 320, and outputs a model having a shape descriptor within a predetermined degree of similarity with a shape descriptor of the query generated by the query-generating unit 300 (operation 430).

If the model-retrieving unit 340 outputs a plurality of instance models or class models, a user may select a predetermined instance model or a predetermined class model from the output models, using the model-selecting unit 348 of the model-retrieving unit 340. If the model-retrieving unit 340 does not output any user-intended model, a user may modify/add query items and repeat the retrieval until the desired model is retrieved. Consequently, the model-retrieving unit 340 may retrieve one model.

If a retrieved model is an instance model (operation 450), the retrieved instance model is refined by the model-refining unit 380 according to an instruction from the user (operation 490). However, if the retrieved model is a class model (operation 450), a parameter value of the retrieved class model is determined as the retrieved class model goes through the model-deformation unit 360 (operation 470). The deformed class model is refined by the model-refining unit 380 according to an instruction from the user (operation 490).

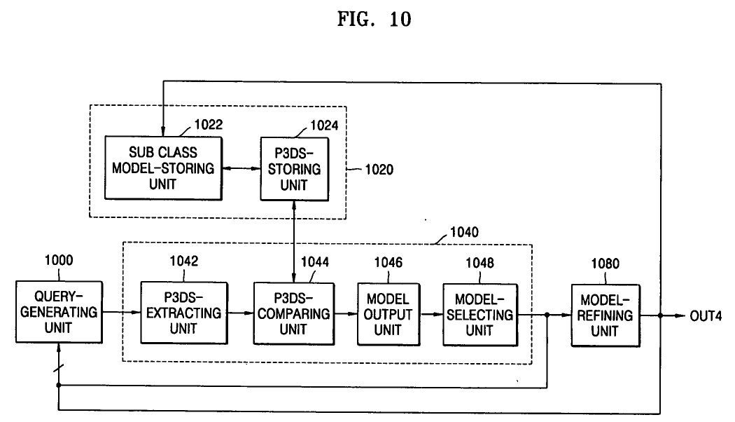

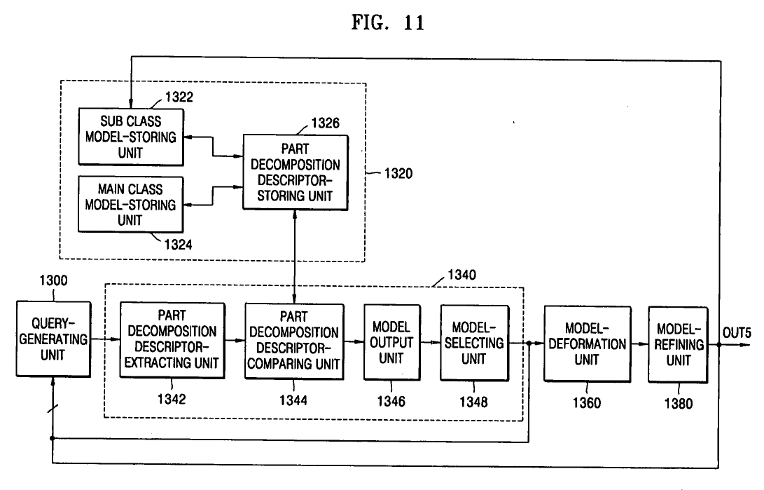

The apparatus for and method of producing graphics contents according to an exemplary embodiment of the present invention have been described with reference to FIGS. 2 through 9. Hereinafter, an apparatus and method of producing graphics contents when a query generated by the query-generating unit 300 is composed of specific query items will now be described with reference to FIGS. 10 through 11.

Specifically, an apparatus for and method of producing graphics contents when shape descriptors of query items and of models stored in the model database 320 are perceptual 3D shape descriptors will be described with reference to FIG. 10.

Also, an apparatus for and method of producing 3D graphics contents when shape descriptors of query items and of models stored in the model database 320 are part decomposition descriptors (PDDs) will be described with reference to FIG. 11.

Both these apparatuses and methods are particular cases of the apparatus and methods for producing 3D graphics contents described here above.

FIG. 10 is a block diagram of an apparatus for producing graphics contents according to another exemplary embodiment of the present invention. The apparatus includes a query-generating unit 1000, a model database 1020, a model-retrieving unit 1040, and a model-refining unit 1080.

The operations of the query-generating unit 1000 and the model-refining unit 1080 of FIG. 10 are identical to those of the query-generating unit 300 and the model-refining unit 380 of FIG. 3. However, the apparatus of FIG. 10 uses only perceptual 3D shape descriptors. Also, class models are not stored in the model database 1020. Meanwhile, OUT 4 indicates graphics contents output by the model-refining unit 1080.

In other words, the model database 1020 stores only instance models. Therefore, unlike the model-retrieving unit 340 of FIG. 3, the model-retrieving unit 1040 generates only retrieved instance models but not retrieved class models. Consequently, the apparatus of FIG. 10 using perceptual 3D shape descriptors does not need a model-deformation unit.

Such a perceptual 3D shape descriptor (hereinafter, called P3DS shape descriptor) will now be described. The P3DS shape descriptor is a shape descriptor which represents a 3D object as an attribute relational graph composed of nodes and edges, which is a part-based representation of the 3D object.

A query item from which such a P3DS shape descriptor is extracted is called a 3D structural sketch (3DSS). In other words, a 3DSS visually represents a P3DS shape descriptor in three-dimensional space. Specifically, a 3DSS may represent a node as an ellipsoid and an edge as a link between ellipsoids.

Human eyes perceive a shape as the composition of parts, similar with the representation of such a shape descriptor, so the shape descriptor is called the Perceptual 3D Shape descriptor.

The P3DS shape descriptor will now be described in more detail. First, the part-based representation of a 3D shape will be described. Part-based representation is to decompose a shape into parts and represent each part of the shape. In the part-based representation, the rotational movement, parallel movement, anisotropic size change, and shape deformation of an object are less influential to the represented shape of the object. A shape may be decomposed using a morphology-based decomposition algorithm or a skeleton-based decomposition algorithm.

FIG. 11 is a block diagram of an apparatus for producing graphics contents according to another exemplary embodiment of the present invention. The apparatus includes a query-generating unit 1300, a model database 1320, a model-retrieving unit 1340, and a model-refining unit 1380.

The operations of the query-generating unit 1300 and the model-refining unit 1380 of FIG. 11 are identical to those of the query-generating unit 300 and the model-refining unit 380 of FIG. 3. However, the apparatus of FIG. 10 uses only perceptual 3D shape descriptors. OUT 5 indicates graphics contents output by the model-refining unit 1380.

A shape descriptor used by the apparatus of FIG. 11 is limited to a part-decomposition descriptor. While the P3DS shape descriptor is for retrieving instance 3D models, the part-decomposition descriptor is for retrieving class models. A model database 1720 included in the apparatus for producing 3D graphics contents using the part-decomposition descriptor can store both instance models and class models. Therefore, the apparatus for producing 3D graphics contents using the part-decomposition descriptor can retrieve a class model and produce 3D graphics contents, unlike the apparatus for producing 3D graphics contents using the P3DS shape descriptor.

In addition to the above described exemplary embodiments, exemplary embodiments of the present invention can also be implemented by executing computer readable code/instructions in/on a medium, e.g., a computer readable medium. The medium can correspond to any medium/media permitting the storing and/or transmission of the computer readable code

The computer readable code/instructions can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. The medium may also be a distributed network, so that the computer readable code/instructions is stored/transferred and executed in a distributed fashion. The computer readable code/instructions may be executed by one or more processors.

As described above, in an apparatus for and method of producing graphics contents and a computer-readable recording medium on which a computer program for executing the method is recorded according to exemplary embodiments of the present invention, a class model is retrieved, deformed, and refined to produce 3D graphics contents quickly and accurately.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. An apparatus for producing graphics contents using a query item, which is a query object indicating graphics contents that a user desires to produce, the apparatus comprising:
a model database storing a plurality of models that can match a predetermined query item and shape descriptors of the models;
a model-retrieving unit comparing a shape descriptor extracted from a given query item with the shape descriptors of the models stored in the model database and outputting one or more models within a predetermined degree of similarity for user selection; and
a model-refining unit refining the user-selected model according to an instruction from the user and generating a user-intended model,
wherein the shape descriptor describes a shape based on properties including geometric and topologic properties.

2. An apparatus for producing graphics contents using a query item, which is a query object indicating graphics contents that a user desires to produce, the apparatus comprising:
a model database storing a plurality of models that can match a predetermined query item and shape descriptors of the models;
a model-retrieving unit comparing a shape descriptor extracted from a given query item with the shape descriptors of the class models stored in the model database and outputting one or more class models within a predetermined degree of similarity for user selection; and
a model-deformation unit deforming properties of the user-selected class model and according the properties of the user-selected class model and properties of the given query item,
wherein the class model is a category representation corresponding to each kind of graphics contents and properties of the class model are determined as variable, and
wherein the shape descriptor describes a shape based on properties including geometric and topologic properties.

3. The apparatus of claim 2, further comprising a model-refining unit refining the class models having deformed properties according to an instruction from the user and generating a user-intended model.

4. The apparatus of claim 1, further comprising a query-generating unit generating a query composed of one or more the query items, wherein the model-retrieving unit receives the query generated by the query-generating unit, compares a shape descriptor extracted from the received query with the shape descriptors of the models stored in the model database, and outputting one or more models within a predetermined degree of similarity.

5. The apparatus of claim 2, further comprising a query-generating unit generating a query composed of one or more the query items, wherein the model-retrieving unit receives the query generated by the query-generating unit, compares a shape descriptor extracted from the received query with the shape descriptors of the class models stored in the model database, and outputting one or more class models within a predetermined degree of similarity.

6. The apparatus of claim 1, wherein the model-retrieving unit comprises:
a shape descriptor-extracting unit extracting the shape descriptor from the given query item;
a shape descriptor-comparing unit comparing the shape descriptor of the models stored in the model database with the extracted shape descriptor; and
a model output unit outputting one or more models within a predetermined degree of similarity based on the result of the comparison.

7. The apparatus of claim 4, wherein the model-retrieving unit comprises:
a shape descriptor-extracting unit receiving the generated query and extracting the shape descriptor from the received query;
a shape descriptor-comparing unit comparing the shape descriptor of the models stored in the model database with the extracted shape descriptor; and
a model output unit outputting one or more models within a predetermined degree of similarity based on the result of the comparison.

8. The apparatus of claim 6, wherein the model-retrieving unit further comprises a model-selecting unit receiving a selection of a model among the outputted models by the user, and the model output unit outputs a plurality of models.

9. The apparatus of claim 6, wherein the model-retrieving unit further comprises a retrieval feedback unit adding the outputted models as the query items.

10. The apparatus of claim 1, wherein the models stored in the model database comprise instance models and class models, the instance models are representative models belonging to each kind of graphics contents and properties of the instance models are determined as invariables, and the class models are category representations corresponding to each kind of graphics contents and properties of the class models are determined as variables.

11. The apparatus of claim 1, wherein the model-refining unit further comprises a refining feedback unit adding the one or more refined models as the query items.

12. The apparatus of claim 1, wherein the model-refining unit further comprises a refined model-adding unit adding the one or more refined models to the model database.

13. The apparatus of claim 4, wherein the query-generating unit comprises:
a node-generating unit generating a plurality of nodes respectively
corresponding to parts of a shape of the graphics contents that the user desires to produce, having properties of the parts, and having a plurality of three-dimensional shapes; and
a three-dimensional structural sketch-generating unit disposing the nodes according to the properties of the nodes.

14. The apparatus of claim 1, wherein the model database stores three-dimensional models.

15. A method of producing graphics contents using a query item, which is a query object indicating graphics contents that a user desires to produce, the method comprising:
generating a query composed of one or more query items;
receiving the query and retrieving one or more models, which can have shape descriptors within a predetermined degree of similarity with a shape descriptor extracted from the received query, from a plurality of models which can match a predetermined query item for user-selection; and
refining the selected model according to an instruction from the user and generating a user-intended model,
wherein the shape descriptor describes a shape based on properties including geometric and topologic properties.

16. A method of producing graphics contents using a query item, which is a query object indicating graphics contents that a user desires to produce, the method comprising:
generating a query composed of one or more query items;
receiving the query and retrieving one or more class models, which can have shape descriptors within a predetermined degree of similarity with a shape descriptor extracted from the received query, from a plurality of models which can match a predetermined query item for user selection; and
deforming properties of the selected class model and according the properties of the selected class mode and properties of the received query,
wherein the class model is a category representation corresponding to each kind of graphics contents and properties of the model is determined as a variable, and the shape descriptor describes a shape based on properties including geometric and topologic properties.

17. The method of claim 16, further comprising refining the selected model having deformed properties according to an instruction from the user and generating a user-intended model.

18. The method of claim 15, wherein the receiving of the query and the retrieving of the one or more models comprise:
receiving the query and extracting the shape descriptor from the received query;
comparing the shape descriptors of the models stored with the extracted shape descriptor; and
outputting one or more models within a predetermined degree of similarity based on the result of the comparison.

19. The method of claim 18, wherein the receiving of the query and the retrieving of the one or more models further comprise receiving a selection of a model among the outputted models by the user, and in the outputting of one or more models, a plurality of models are outputted.

20. The method of claim 18, wherein the receiving of the query and the retrieving of the one or more models further comprise adding the outputted models as the query items and generating the query.

21. The method of claim 15, wherein the refining of the selected model and the generating of the user-intended model further comprise adding the one or more refined models as the query items and generating the query.

22. The method of claim 15, wherein the refining of the selected model and the generating of the user-intended model further comprise adding the refined one or more models and shape descriptors of the refined one or more models to the models stored and the shape descriptors of the stored models and generating the query.

23. At least one computer-readable medium storing instructions that control at least one processor to perform a method of producing graphics contents using a query item, which is a query object indicating graphics contents that a user desires to produce, the method comprising:
generating a query composed of one or more query items;
receiving the query and retrieving one or more models for user selection, which can match have shape descriptors within a predetermined degree of similarity with a shape descriptor extracted from the received query, from a plurality of models which can match a predetermined query item; and
refining the selected model according to an instruction from the user and generating a user-intended model,
wherein the shape descriptor describes a shape based on properties including geometric and topologic properties.

24. At least one computer-readable medium storing instructions that control at least one processor to perform a method of producing graphics contents using a query item, which is a query object indicating graphics contents that a user desires to produce, the method comprising:
generating a query composed of one or more query items;
receiving the query and retrieving one or more models for user selection, which can have shape descriptors within a predetermined degree of similarity with a shape descriptor extracted from the received query, from a plurality of models which can match a predetermined query item; and
deforming properties of the selected model and according the properties of the selected model and properties of the received query,
wherein the model is a category representation corresponding to each kind of graphics contents and properties of the model is determined as a variable, and the shape descriptor describes a shape based on properties including geometric and topologic properties.

25. The apparatus of claim 2, wherein the model-retrieving unit comprises:
a shape descriptor-extracting unit extracting the shape descriptor from the given query item;
a shape descriptor-comparing unit comparing the shape descriptor of the models stored in the model database with the extracted shape descriptor; and
a model output unit outputting one or more models within a predetermined degree of similarity based on the result of the comparison.

26. The apparatus of claim 25, wherein the model-retrieving unit further comprises a model-selecting unit receiving a selection of a model among the outputted models by the user, and the model output unit outputs a plurality of models.

27. The apparatus of claim 25, wherein the model-retrieving unit further comprises a retrieval feedback unit adding the outputted models as the query items.

28. The apparatus of claim 5, wherein the model-retrieving unit comprises:
a shape descriptor-extracting unit receiving the generated query and extracting the shape descriptor from the received query;
a shape descriptor-comparing unit comparing the shape descriptor of the models stored in the model database with the extracted shape descriptor; and
a model output unit outputting one or more models within a predetermined degree of similarity based on the result of the comparison.

29. The apparatus of claim 3, wherein the model-refining unit further comprises a refining feedback unit adding the one or more refined models as the query items.

30. The apparatus of claim 3, wherein the model-refining unit further comprises a refined model-adding unit adding the one or more refined models to the model database.

31. The apparatus of claim 2, wherein the model database stores three-dimensional models.

32. The method of claim 16, wherein the receiving of the query and the retrieving of the one or more models comprise:
receiving the query and extracting the shape descriptor from the received query;
comparing the shape descriptors of the models stored with the extracted shape descriptor; and
outputting one or more models within a predetermined degree of similarity based on the result of the comparison.

33. The method of claim 32, wherein the receiving of the query and the retrieving of the one or more models further comprise receiving a selection of a model among the outputted models by the user, and in the outputting of one or more models, a plurality of models are outputted.

34. The method of claim 32, wherein the receiving of the query and the retrieving of the one or more models further comprise adding the outputted models as the query items and generating the query.

35. The method of claim 17, wherein the refining of the selected model and the generating of the user-intended model further comprise adding the refined one or more models and shape descriptors of the refined one or more models to the models stored and the shape descriptors of the stored models and generating the query.

36. The method of claim 17, wherein the refining of the selected model and the generating of the user-intended model further comprise adding the refined one or more models and shape descriptors of the refined one or more models to the models stored and the shape descriptors of the stored models and generating the query.

37. An apparatus for producing graphics contents using a query item, which is a query object indicating graphics contents that a user desires to produce, the apparatus comprising:
a model-retrieving unit comparing a shape descriptor extracted from a given query item with shape descriptors of models stored in a model database and outputting one or more models within a predetermined degree of similarity for user selection; and
a model-refining unit refining a user-selected model according to an instruction from the user and generating a user-intended model,
wherein the shape descriptor describes a shape based on properties including geometric and topologic properties.

38. An apparatus for producing graphics contents using a query item, which is a query object indicating graphics contents that a user desires to produce, the apparatus comprising:
a model-retrieving unit comparing a shape descriptor extracted from a given query item with shape descriptors of class models stored in a model database and outputting one or more class models within a predetermined degree of similarity for user selection; and
a model-deformation unit deforming properties of a user-selected class model and according properties of the user-selected class model and properties of the given query item,
wherein the class model is a category representation corresponding to each kind of graphics contents and properties of the class model are determined as a variable, and
wherein the shape descriptor describes a shape based on properties including geometric and topologic properties.
